(19) United States
(12) Patent Application Publication
(10) Pub. No.: US 2024/0240414 A1
(43) Pub. Date: Jul. 18, 2024

(54) Concrete Screed with Vision System

(71) Applicant: Ligchine International Corporation, Floyds Knobs, IN (US)

(72) Inventors: Peter A. Ligman, Darien, WI (US); Joshua Rocholl, Floyds Knobs, IN (US); Kyle Hohmann, Floyds Knobs, IN (US); Justin Foltz, Floyds Knobs, IN (US); Brad Davis, Floyds Knobs, IN (US)

(21) Appl. No.: 18/414,213

(22) Filed: Jan. 16, 2024

Related U.S. Application Data
(60) Provisional application No. 63/480,033, filed on Jan. 16, 2023.

(51) Int. Cl. E01C 19/42; B60R 1/24; E04F 21/24

(52) U.S. Cl. CPC E01C 19/42; B60R 1/24; E04F 21/241; B60R 2300/102; B60R 2300/105; B60R 2300/70; B60R 2300/80; E01C 2301/00

(57) ABSTRACT

An apparatus for screeding concrete includes a frame, a plurality of drive wheels secured thereto, an extendable and retractable boom secured to the frame and a screed head secured to a distal end of the boom. The apparatus includes a control system operatively coupled to a plurality of cameras secured at points around the apparatus and an operator interface for displaying the view of each camera.

### FIELD OF THE INVENTION

The embodiments described relate generally to an apparatus for troweling or screeding concrete and more specifically to a concrete screed apparatus for screeding a poured concrete surface that includes a plurality of vision sensors, thereby providing an operator the ability to move accurately and quickly position a screed head that is extended outwardly on a boom, without the need to move to the front of the machine to confirm the positioning of the screed head, or have a spotter to assist with screed head positioning. Furthermore, the embodiments include a plurality of visions sensors or cameras that enable an operator to view areas behind and to the side of the screed apparatus utilizing an operator interface or display to assist in positioning the screed apparatus during the screeding process.

### BACKGROUND OF THE INVENTION

In the construction industry when liquid concrete is poured to produce a finished surface it must be quickly and carefully smoothed or screeded, so that when the concrete sets it produces an even, level surface. Since this level surface is almost always a foundation for additional construction, machine base applications, or for vertical storage such as warehousing and shelving space, it is highly desirable to produce a surface that is consistently level over its entire area. In large poured areas it is unwieldy and labor intensive to manually level and smooth a poured concrete surface as well as extremely difficult to maintain a consistent finished grade.

In order to aid in the screeding of large surface area concrete pours, a variety of concrete screeding or troweling machines have been accepted into use in the art. These machines typically include a screed head comprising a flat troweling surface for contacting the poured concrete mounted on a boom that is mechanically extended and retracted across the concrete surface to produce a smooth surface finish. Many of these prior art devices include various systems for leveling the screed head relative to a reference plane such that the finished surface is relatively flat once it is screeded.

Many screed devices often comprise a frame structure on which a hydraulic boom is secured, and from which the boom is extended. A screed head that may include finishing elements such as an auger, a plow, and a vibrating member mounted thereon for smoothing the poured concrete is secured to the boom on a distal end thereof and leveled, using a wide variety of known leveling techniques, and is then retracted back across the poured concrete surface to achieve a smooth level finished surface. The leveling process for the screed head is typically a continuous process that maintains a level grade during the retraction of the boom.

The leveling systems in prior art screeding devices may encompass laser eyes mounted on the screed head structure that detect a laser beam projected at a predetermined level reference height above grade. Thus the screed head may be adjusted using a wide variety of adjustment mechanisms to a predetermined grade level by aligning the laser eyes mounted to the head with the projected reference laser beam. Furthermore, many of these devices provide automated systems for adjusting the screed head upwardly or downwardly to a level reference plane, thus obviating the need for manual alignment. In some systems, the automated adjustment of the screed head requires the use of multiple sensors and actuators mounted to, or proximate the screed head along with the concomitant wiring and computerized control systems required to effect the necessary leveling adjustments.

One significant disadvantage with prior art concrete screeds is the difficulty an operator or user has in seeing exactly where the screed head is positioned when operating the screed. The screed operator starts a “screeding pass” by extending the screed head outwardly as far as the boom will go over a poured concrete surface, then lowers the screed head to the surface and simultaneously levels and retracts the screed head over the surface to provide a smooth finish. However, at the beginning of the pass, the screed head can be quite far away from the operator, who may have to stand in the poured concrete to precisely position the head. For example, the screed head may need to be positioned near stub-outs for conduits and plumbing lines, heating and cooling ducts, plumbing chases, and decorative members or other obstacles that may extend up through a poured concrete surface. Using prior art machines to finish these surfaces requires a great deal of guess work in positioning the screed head accurately. Additionally, it may be difficult to determine exactly where the rear of the screed is positioned as it is moved around the pour area, sometimes in restricted spaces with many obstacles.

Accordingly, there is a need in the art for a screed apparatus that provides the operator the ability to view or see critical areas of the apparatus such as the precise position of the screed head as it operates during a concrete finishing operations. Furthermore, there is a need for a screed apparatus that enables a user or operator to view the rear or sides of the screed as it is being positioned adjacent to a concrete pour to avoid obstacles.

### SUMMARY OF THE INVENTION

The embodiments described herein provide for a wheeled screed having a frame mounted boom that terminates in a screed head for contacting, leveling, and finishing a poured concrete surface as the screed head is retracted across the surface by the boom. The system includes a control system having a microprocessor, or a plurality thereof, data memory, and a plurality of inputs and outputs for actuating, operating and monitoring all screed functionality. The control system also is operatively coupled to an operator interface that permits an operator to select and operate all screed functionality from the interface.

The control system is operatively coupled to a plurality of cameras or vision systems that provide video feeds to an operator interface. The cameras may be digital cameras or any other camera suitable for use in an industrial environment. Cameras are strategically positioned around and secured to the screed to provide advantageous views of the screed head and boom as the screed is used to finish a concrete surface, as well as provide views of the sides and rear of the screed as it is being moved around a pour.

A boom camera or cameras are provided proximate the screed head to enable an operator to view the screed head as it is being positioned for a screed pass. Furthermore, front/side and rear body cameras are positioned to provide video feed to the operator interface to enable the screed to easily be positioned for a screeding pass or maneuvered around a job site.

Furthermore, a control system may provide the operator the ability to select any camera to view on the operator interface or alternatively the control system may be programmed to automatically select a preferred camera view depending upon the sensed operation of the screed.

Other features, objects and advantages of the present invention will become apparent from the detailed description of the drawing Figures taken in conjunction with the appended drawing Figures.

### BRIEF DESCRIPTION OF THE DRAWING FIGURES

FIG. 1 is a side view of a concrete screed with a retracted boom in accordance with some embodiments;

FIG. 2 is a top view of a concrete screed with a retracted boom in accordance with some embodiments;

FIG. 3 is a partial perspective view of a concrete screed with a retracted boom in accordance with some embodiments;

FIG. 4 is a partial perspective view of a concrete screed with a retracted boom in accordance with some embodiments;

FIG. 5 is a partial perspective view of a concrete screed in accordance with some embodiments;

FIG. 6 is a partial perspective view of a concrete screed in accordance with some embodiments:

FIG. 7 is a partial perspective view a rear underneath portion of a concrete screed in accordance with some embodiments; and

FIG. 8 is a block diagram of a control system in accordance with some embodiments.

### DETAILED DESCRIPTION OF THE PREFERRED EMBODIMENT(S)

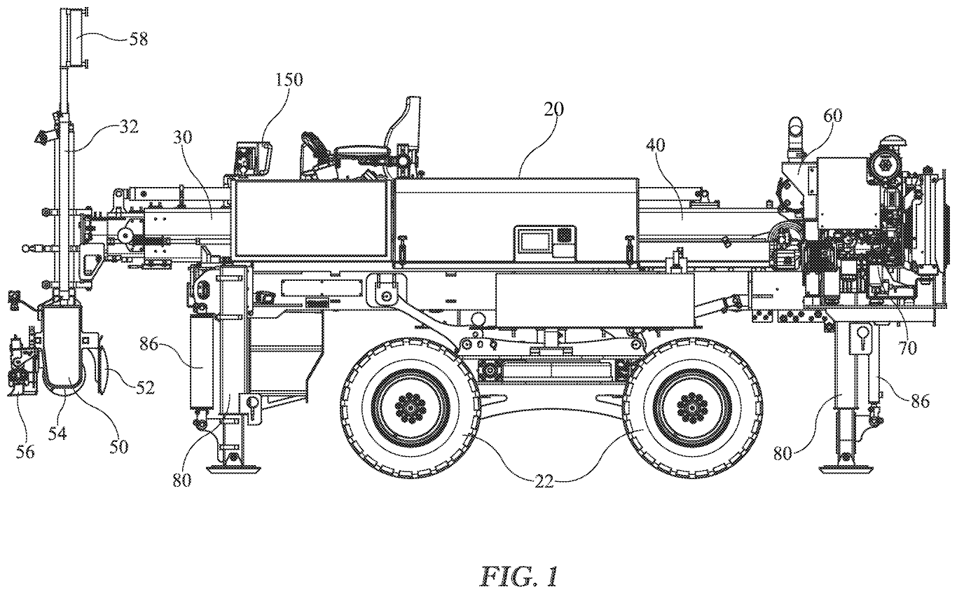

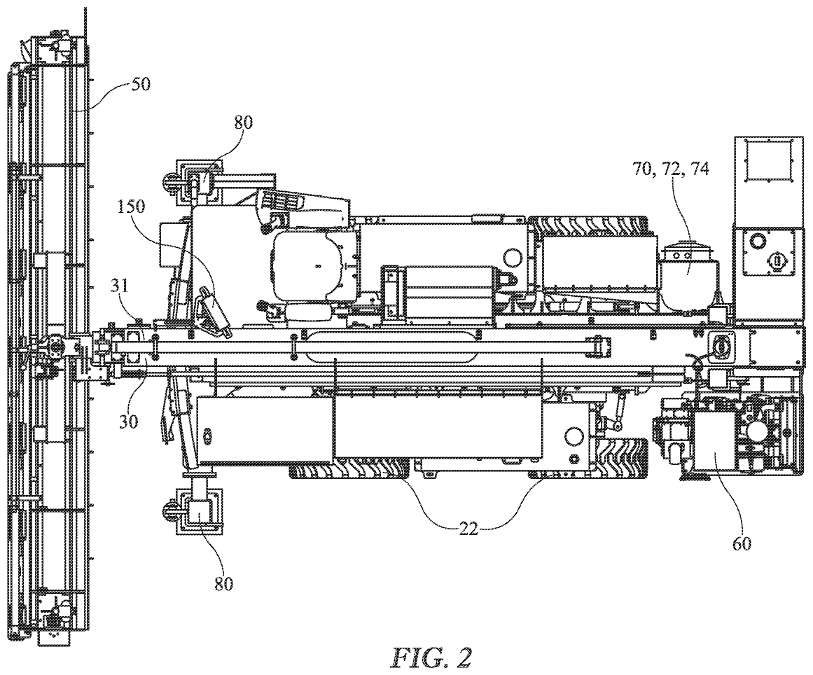

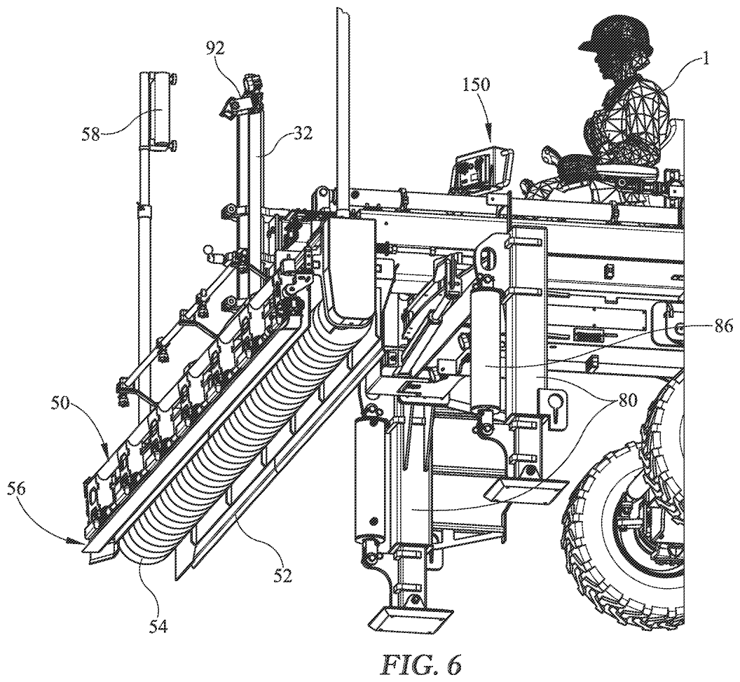

Referring to drawing FIGS. 1-8, and in accordance with some aspects and embodiments a concrete screed apparatus 20, known in the art as a screed 20, includes a plurality of powered wheels 22, a hydraulically actuated telescopic boom assembly 30 and a rigid frame assembly 40 that boom assembly 30 is secured to.

The screed apparatus 20 may also comprise a power source 60 such as a conventional internal combustion engine or an electric motor and battery, each having an output shaft coupled to a hydraulic assembly 70 including a hydraulic pump 72, for supplying pressurized hydraulic fluid to a plurality of components necessary to operate screed 20 through operation of a plurality of electrically actuated control valves 74 and various pressure and temperature sensors for monitoring and confirming screed 20 operation. Furthermore power source 60 and hydraulic assembly 70 may be mounted or secured at various points on or around frame assembly 40 as is required for providing mechanical balance of screed 20 as well as simple routing of concomitant hydraulic lines and electrical wiring.

The extendable and retractable boom assembly 30 includes a distal end 32 to which is secured a screed head 50 for smoothing and leveling poured concrete. One of ordinary skill in the art will recognize that a wide variety of boom assemblies 30 and frame assemblies 40 may be employed in the construction of screed apparatus 20 without departing from the scope thereof. Furthermore, a unitary screed head assembly 50 that may include at least one of a plow 52, an auger 54 or augers 54, and a finish blade 56 is secured to a distal end 31 of boom assembly 30. In some aspects and embodiments screed head assembly 50 may include only one finish blade 56 or only one or two augers 54, a roller or rollers (not shown), or any combination of these smoothing members without departing from the scope of the embodiments described. Screed head 50 may in some embodiments include a plurality of leveling eyes 58 secured thereto which are used to level boom assembly 30, and thus screed head 50, to a reference plane, thereby providing a level finished concrete surface as screed head 50 is retracted toward screed 20. In some embodiments screed head 50 may be secured to boom assembly 30 via a central T-post or 32 or equivalent structure. Furthermore, in one embodiment leveling eyes 58 may comprise laser transmitters that emit light that is received by a receiver, thereby providing the ability to adjust screed head 50 to a reference plane, as is known in the art.

In further aspects and embodiments a plurality of adjustable stabilization legs 80 are secured in a generally vertical orientation to frame assembly 40 at a plurality of points around the perimeter thereof. As shown in the drawing Figures, in one exemplary embodiment two opposed legs 80 are secured to frame assembly 40 at a forward end 41 thereof, as described in more detail below, while a single leg 80 is secured to a rear end 43 of frame assembly 40. One of ordinary skill in the art will understand that the number and positioning of legs 80 around frame assembly 80 may be varied without departing from the scope of the embodiments. Each leg 80 is further secured to a hydraulic cylinder 86 which is also secured to frame 40 at a point, and that is utilized to level boom assembly 30 with respect to a reference plane, thereby leveling entire screed apparatus 20 as well as screed head 50. This feature provides an extremely level finished concrete surface, since boom 30 and screed head 50, once leveled, are unable to move with respect to a desired reference plane.

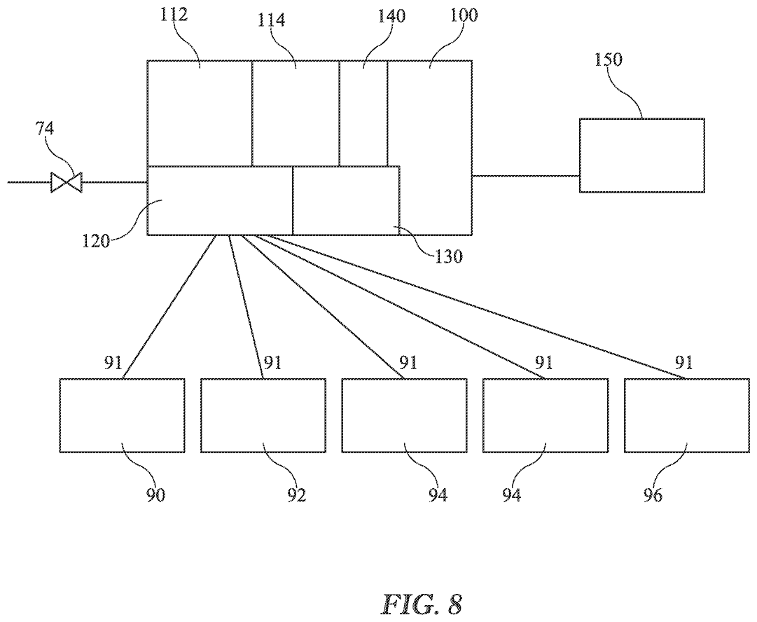

Referring to FIG. 8, in some embodiments screed 20 includes a control system 100 which may include a microprocessor 110, data memory 112, inputs 120 and outputs 130, a wireless transceiver 140 or transceivers, communications interfaces 142, for example an Ethernet communications interface 142, and requisite wiring to electrically connect control system 100 to screed 20 mechanical and propulsion components such as electric motors, internal combustion engine, hydraulic pump(s), electrical control valves, laser sensors, thermal sensors, hydraulic valves, switches, cameras 90 and all the requisite control and feedback components of the screed Furthermore, an operator interface 150 or human machine interface (HUI) 150 is operatively coupled to control system 100 to provide ease of monitoring and control of all aspects of screed 20 operation. In some embodiments HUI 150 may comprise a general purpose computer with a keyboard or keypad and a display, or a touch screen or equivalent display device, or a smart phone or similar digital device. Microprocessor 110 may be provided with suitable instructions to enable operation of screed 20 in its various functions as described herein. Furthermore, HUI 150 may be operatively coupled to control system 20 either wirelessly, or through a hardwired connection without departing from the scope of the various embodiments.

As best seen in FIGS. 1-3, HUI 150, or an operator display screen that operates as a portion or component of HUI 150, may be mounted or secured to screed 20 proximate an operator seat 22 for screeds 20 that are “ride-on”. In other embodiments operator 1 may control screed 20 from a handheld HUI 150 that is not mounted on screed 20, but rather is capable of being carried by operator 1 as the screeding process proceeds. In these embodiments HUI 150 may employ wireless communications with control system 100 via wireless transmitter/transceiver 140.

In some aspects and embodiments a plurality of cameras 90 are secured to screed 20 at a plurality of points thereon for providing operator 1 the ability to view areas around screed 20 with greater clarity. Each camera 90 includes an output 91 operatively coupled to an input 120 of control system 100 to provide a camera signal that translates to a video image that may be displayed on HUI 150 for operator 1. In some embodiments digital cameras 90 are employed to provide display images, for example a high-resolution IP camera that employs Ethernet communications protocol to communicate with control system 100 via an Ethernet communications module. A wide variety of equivalent cameras 90 may be also employed in the various embodiments described herein without departing from the scope of the described embodiments.

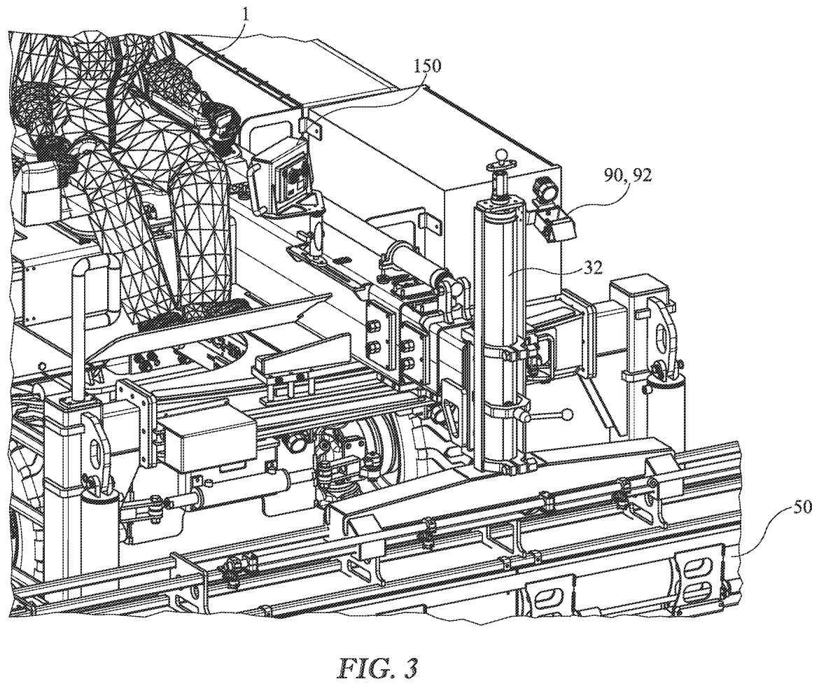

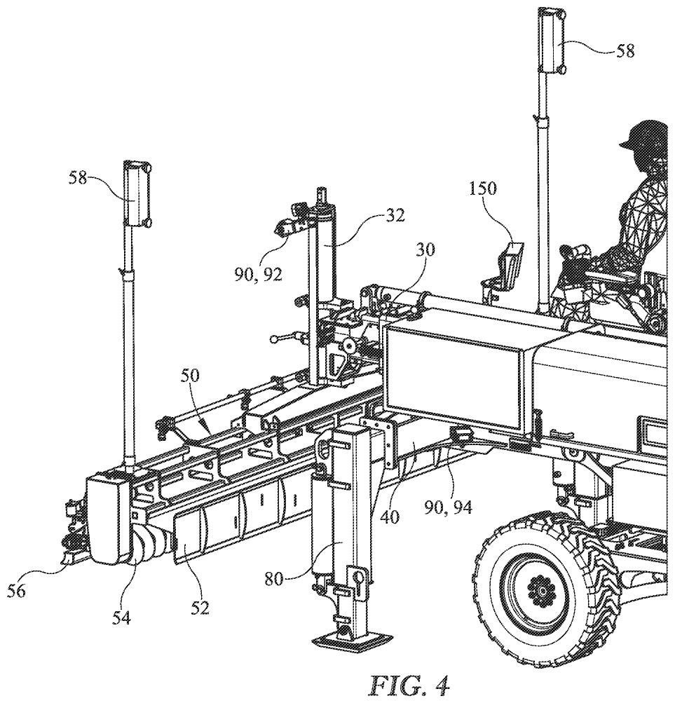

In some aspects and embodiments as best seen in FIGS. 3 and 4, a boom camera 92 or an equivalent vision system may be secured at a point on boom 30 proximate screed head, for example on T-post 32. Boom camera 92 has an output 91 that is operatively connected to controller 100, which in turn provides a signal to HUI 150 so that boom camera 92's view can be continuously monitored by operator 1. By mounting boom camera 92 on or proximate the screed head 50, operator 1 can accurately view the positioning of screed head 50 as boom 30 extends outwardly away from the position of operator 1 and is retracted during the screeding pass. This feature provides a significant improvement over the prior art since operator 1 may accurately position screed head 50 prior to beginning the screeding pass, and also move or reposition screed head 50 during the pass thereby avoiding obstacles and generally enabling more efficient screed 20 operation.

In some embodiments, when boom 30 is extended outwardly to begin a screeding pass operator 1 views precise position of screed head 50 by monitoring boom camera 92 feed to HUI 150, prior to bringing screed head 50 down to contact the poured concrete surface and begin the screeding pass. In certain embodiments, when operator 1 begins the screeding pass by initiated the extension of boom 30, boom camera 92's field of vision is automatically displayed on HUI 150 to operator 1 to enable precise positioning of screed head 50 so that there are no gaps the finished surface and also so that the screeding pass is as efficient as possible, thereby avoiding screeding an area more than once. The boom camera 92 feed continues to be displayed on HUI 150 until the screeding pass is complete, for example when boom 30 is fully retracted and operator 1 raises screed head 50 to reposition screed 20 for a another pass. Boom camera 92 display feed is thus continuously viewed when booming in and out, to enable operator 1 to ensure screed head 50 and/or boom 30 don't encounter or contact any obstacles while in motion.

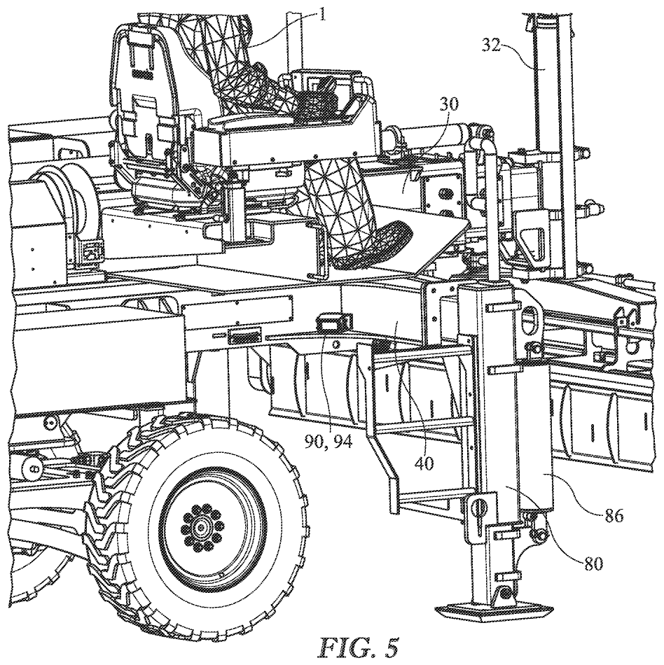

Referring again to FIGS. 4 and 5, and in accordance with some embodiments a forward body camera 94, or a plurality thereof, may be mounted at a point on frame 40, for example proximate the front end of screed 20, and be positioned to view the area to either side of frame 40 as well as to the rear of screed head 50 and front wheels 22. Forward body camera 94 also has an output 91 that is operatively connected to an input 120 of controller 100, which in turn provides a signal to HUI 150 so that forward body camera 94's view can be continuously or selectively monitored by operator 1. By mounting forward body camera 94 on or proximate frame 40 looking rearwardly and to a side of screed 20, operator 1 can accurately view the positioning of screed 20 as it is being repositioned between screeding passes. In some aspects and embodiments a pair of forward body cameras 94 are provided, one each secured to a point proximate operator 1, and having a field of view that permits vision to the side and rear of screed 20. In FIGS. 4 and 5, forward body cameras 94 are mounted on frame 50, proximate a front end of screed 20, although a wide variety of mounting positions may be used to provide adequate fields of view for cameras 94.

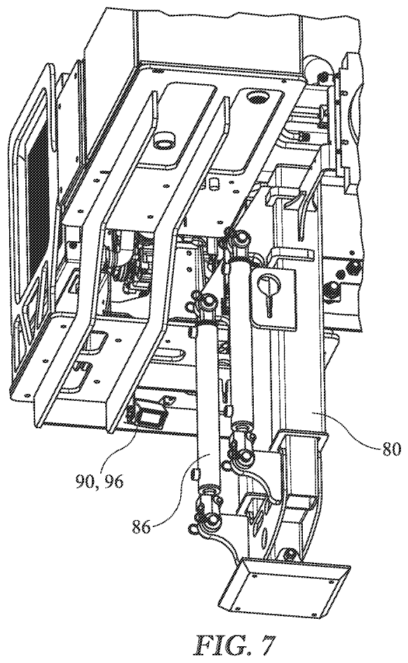

As best seen in FIG. 7, a rear body camera 96, or a plurality thereof, may be mounted at a rear portion of screed 20, proximate a rear stabilization leg 80, to view the area below and behind screed 80. Similar to boom camera 92 and forward body cameras 94, rear body camera 96 also includes an output 91 that is operatively connected to an input 120 of controller 100, which in turn provides a video signal to HUI 150 so that rear body camera 96's view can be continuously or selectively monitored by operator 1. By mounting rear body camera 96 on or proximate rear stabilization leg looking rearwardly of screed 20, operator 1 can accurately view the positioning of screed 20 as it is backed up, either for being repositioned between screeding passes or when loading or unloading screed 20 from a transport trailer or vehicle.

In operation, control system 100 may be suitably programmed with an instruction set to provide various camera 92, 94, 96 viewing functions and capabilities for display on HUI 150 so that operator 1 can selectively view images from a specific camera, or a selected set of cameras 92, 94, 96 to monitor the various camera views during driving, screeding, or loading screed 20 onto a trailer or truck for transport. In some aspects and embodiments microprocessor 110 may be provided with suitable programming instructions to operate the various camera 92, 94, 96 displays in an “automatic mode” where controller 100 automatically switches the display on HUI 150 to the camera 92, 94, 96 view most likely to be used based upon the operation of screed 20.

In some exemplary but non-limiting embodiments when operator 1 begins “booming out”, i.e., extending boom 30, to begin a screeding pass, as sensed by the controller 100 outputs 130 to the hydraulic valve or valves 74 controlling boom 30 operation, control system 100 will provide HUI 150 with the display of boom camera 92 so that operator 1 can view screed head 50 position as boom 30 extends outwardly to initiate the screeding pass. This “boom out” view may, in some embodiments, be maintained until boom 30 is completely retracted, for example as sensed by controller 100 monitoring outputs 130 to boom 30 hydraulic control valves, or until screed head 50 is moved off the concrete surface signaling the end of a screed pass.

Similarly, and in accordance with other embodiments, when control system 100 detects that operator is moving screed 20, for example by detecting operation of outputs 130 to hydraulic motors driving screed 20 wheels 22, controller 100 may automatically switch the HUI 150 display to the views front 94 and rear body 96 cameras so operator 1 can quickly and easily determine exactly where screed 20 is moving in space, without the need to pivot and guess or estimate the exact location of screed 20 in space. As screed 20 is being moved parallel to a concrete pour to finish an adjacent section, front body cameras 94 may be automatically selected by controller 100 so operator 1 may quickly determine whether any impediments are present to moving screed 20 and how far to move before beginning the next pass and booming out. Furthermore, when screed 20 is being loaded for transport onto a trailer or truck, controller 100 may display the front body cameras 94, and/or the rear body camera 96 to operator 1 for ease of loading.

In some embodiments HUI 150 may include a plurality of camera selection icons (or screen selection icons or the equivalent) whereby operator 1 may simply manually select a camera 90 view, or a plurality of camera 90 views, to monitor on HUI 150, as desired for a given operation. In these embodiments operator 1 may select any or all cameras 90 to view depending upon the operation need and situation.

In some embodiments control system 100 may include, through a selection on HUI 150, a “screed mode” icon that may be selected to initiate the process of elevate screed 20 on its stabilization legs and “booming out” to begin the screeding pass. When “screed mode” is selected, control system 100 automatically displays boom camera 92 on HUI 150 so that operator 1 can monitor and guide screed head 50 during operation. Once operator 1 removes screed 20 from “screed mode”, control system 100 selects front body cameras 94 and/or rear body camera 96 to display on HUI 150.

In a yet further embodiment, control system 100 may include, through a selection on HUI 150 a “drive mode” icon that may be selected to automatically lower screed 20 onto its wheels to prepare for driving. In this embodiment control system 100 selects front body cameras 94 and/or rear body camera 96 to display on HUI 150 so operator 1 can quickly orient screed 20 as it is being driven.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or.” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either.” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B.” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the embodiments are not limited in its application to the details of construction and the arrangement of components set forth in the description or illustrated in the drawings. The invention is capable of other embodiments and of being practiced or of being carried out in various ways. Unless limited otherwise, the terms “connected,” “coupled,” “in communication with,” “secured,” and “mounted,” and variations thereof herein are used broadly and encompass direct and indirect connections, couplings, and mountings. In addition, the terms “secured” and “mounted” and variations thereof are not restricted to physical or mechanical connections or couplings.

While the present invention has been shown and described herein in what are considered to be the preferred embodiments thereof, illustrating the results and advantages over the prior art obtained through the present invention, the apparatus disclosed herein is not limited to those specific embodiments. Thus, the embodiments shown and described herein are to be taken as illustrative only and other embodiments may be selected without departing from the scope of the apparatus, as set forth in the claims appended hereto.

We claim:

1. An apparatus for screeding concrete to produce a level finished surface comprising:
a frame having a front end and rear end, said frame having a pair of spaced vertically oriented stabilization legs secured to a front end thereof and at least one vertically oriented stabilization leg secured to a rear end thereof, and said frame being secured to a plurality of drive wheels;
an extendable and retractable boom assembly secured to said frame at a first end and to a screed head at a second end;
a controller having a processor, a data memory, and a plurality of inputs and outputs for receiving and accepting signals, and an operatively coupled user interface for operating said apparatus, said user interface having a visual display operatively coupled thereto; and
at least one boom camera mounted proximate said screed head, said camera operatively coupled to said controller to provide a signal to said display, whereby an operator can monitor the view from said boom camera.

2. The apparatus as claimed in claim 1 comprising:
a plurality of body cameras mounted at various points around said apparatus, each of said body cameras operatively coupled to said controller to provide a signal to said display, whereby an operator can monitor the view from said body cameras.

3. The apparatus as claimed in claim 2 wherein said body cameras comprise:
a pair of forward body cameras mounted proximate said frame front end, said forward body cameras oriented for viewing to the rear and each side of said apparatus.

4. The apparatus as claimed in claim 3 wherein said body cameras comprise:
a rear body camera mounted proximate said frame rear end, said rear body camera oriented for viewing to the rear of said apparatus.

5. The apparatus as claimed in claim 4 wherein said cameras comprise digital cameras.

6. An apparatus as claimed in claim 4 comprising:
an instruction set for said controller, whereby said instruction set provides a plurality of automatic camera view modes for viewing on said operator interface display.

7. The apparatus of claim 6 wherein a one of said automatic camera view mode includes a screed mode whereby said controller displays said boom camera view on said operator interface display when said controller senses the initiation of a screeding operation.

8. The apparatus of claim 6 wherein said automatic camera view mode includes a drive mode whereby said controller displays said forward body camera views and said rear body camera view on said operator interface display when said controller senses the operation of any of said plurality of drive wheels.

9. The apparatus of claim 6 wherein said instruction set provides a manual camera view mode, thereby enabling an operator to select at least one of said cameras to view on said operator interface display.

10. An apparatus for screeding concrete to produce a level finished surface having a frame, a plurality of drive wheels secured to said frame, an extendable and retractable boom secured to said frame, and a screed head secured to said boom at a distal end comprising:
a controller having a processor, a data memory, and a plurality of inputs and outputs for receiving and accepting signals, and an operatively coupled user interface for operating said apparatus, and an instruction set for operating said controller, said user interface having a visual display operatively coupled thereto; and
at least one camera mounted proximate said screed head, said camera operatively coupled to said controller to provide a signal to said display, whereby an operator can monitor the view from said boom camera.

11. The apparatus as claimed in claim 10 wherein said cameras comprise:
a boom camera mounted proximate said screed head, said boom camera oriented for viewing the position of said screed head; and
a pair of forward body cameras mounted proximate said frame front end, said forward body cameras oriented for viewing to the rear and each side of said apparatus.

12. The apparatus as claimed in claim 11 wherein said cameras comprise:
a rear body camera mounted proximate said frame rear end, said rear body camera oriented for viewing to the rear of said apparatus.

13. The apparatus as claimed in claim 11 wherein said cameras comprise digital cameras.

14. The apparatus as claimed in claim 12 wherein said instruction set provides a manual camera selection mode, a drive mode camera view, and a screed mode camera view for displaying said camera images on said operator interface display:
an instruction set for said controller, whereby said instruction set provides a plurality of automatic camera view modes for viewing on said operator interface display.

15. The apparatus of claim 14 wherein said screed mode is selected by said controller to display said boom camera view on said operator interface display when said controller senses the initiation of a screeding operation.

16. The apparatus of claim 14 wherein said drive mode is selected by said controller to display said forward body camera and rear body camera views on said operator interface display when said controller senses the operation of any of said plurality of drive wheels.

17. The apparatus of claim 14 wherein said manual camera selection mode, enables an operator to select at least one of said cameras to view on said operator interface display.
